(19) United States
(12) Patent Application Publication
(10) Pub. No.: US 2006/0050472 A1
(43) Pub. Date: Mar. 9, 2006

(54) Monitor frame with integrated handle structure

(76) Inventor: Yin-Hung Chen, Taipei (TW)

Correspondence Address: Yi-Wen Tseng, 4331 Stevens Battle Lane, Fairfax, VA, 22033, US

(21) Appl. No.: 10/934,585

(22) Filed: Sep. 3, 2004

(51) Int. Cl. G06F 1/16

(52) U.S. Cl. 361/681

(57) ABSTRACT

A monitor frame with an integrated handle structure, which includes a display, and a frame body which is securely connected to the display. This frame body is made up of a top beam, a left beam, a right beam and a bottom beam which are assembled together. The integrated handle is provided by the top beam which forms a receptive space between a portion of the frame body and the display. It is this receptive space which enables a hand to grasp the integrated handle. By providing such a handle on the top of the monitor, the present invention is easy to carry. Further, when the integrated handle is used as a fixed point, the monitor can be used while it is hanging. The present invention provides a monitor with the ability to quickly adapt to differing environments.

### BACKGROUND OF THE INVENTION

The present invention relates in general to a monitor frame, and more particularly, to a monitor frame with an integrated handle structure to facilitate ease of carrying.

Currently, because PC gaming has become quite stylish the number of serious PC gamers has increased. This increase in the number of PC gamers has not only made the PC gaming industry prosperous, but has also made the LCD monitor and mini PC system standard equipment for many consumers. Many of these PC gamers, in order to improve their gaming skill and enhance their competition experience, travel to large scale PC gaming competitions. Often, when attending these large scale competitions PC gamers will bring their own uniquely designed game systems with them. It is because of the PC gamers' desire for mobile computer equipment that the issue of an easy to carry monitor needs to be addressed.

A conventional monitor includes a display, a supporting stand, and a base mount. The display of a conventional monitor is a flat rectangle. The top of the supporting stand, which is usually cylindrical in shape, connects to the center portion of the rear of the display. The base mount is connected to the bottom of the supporting stand. The base mount is stable because of its large area and is designed to stand on any plane such as a table. It is with these three basic components that the structure of a conventional monitor is formed.

However, the conventional monitor has two elementary problems. First, in order to transport such a monitor, a consumer must disassemble the monitor into its component parts: the display, the supporting stand, and the base mount. These component parts must further be organized and stored, usually, within a box. This disassembly process greatly hinders the mobility of a PC gamer's system. Second, a conventional monitor is only capable of standing on a smooth plane; it is not easily adaptable to differing surroundings. These two problems decrease both the conventional monitor's utility and its economic efficiency.

### BRIEF SUMMARY OF THE INVENTION

The present invention provides a monitor frame with an integrated handle structure. By providing such a handle on the top of the monitor, the present invention is easy to carry. Further, when the integrated handle is used as a fixed point, the monitor can be used while it is hanging. The present invention provides a monitor with the ability to quickly adapt to differing environments.

The monitor frame provided by the present invention includes a display, and a frame body which is securely connected to the display. This frame body is made up of a top beam, a left beam, a right beam and a bottom beam which are assembled together. The integrated handle is provided by the top beam which forms a receptive space between a portion of the frame body and the display. It is this receptive space which enables a hand to grasp the integrated handle.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These as well as other features of the present invention will become more apparent upon reference to the drawings therein:

FIG. 1 is an exploded view of the first embodiment of the present invention.

FIG. 2 is a perspective view of the first embodiment of the present invention fully assembled.

FIG. 3 is perspective view of the first embodiment of the present invention assembled with a supporting member.

FIG. 4 is a perspective view of the second embodiment of the present invention fully assembled.

FIG. 5 is a perspective view of the third embodiment of the present invention fully assembled.

FIG. 6 is a perspective view of the fourth embodiment of the present invention fully assembled.

FIG. 7 is a perspective view of the fifth embodiment of the present invention fully assembled.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

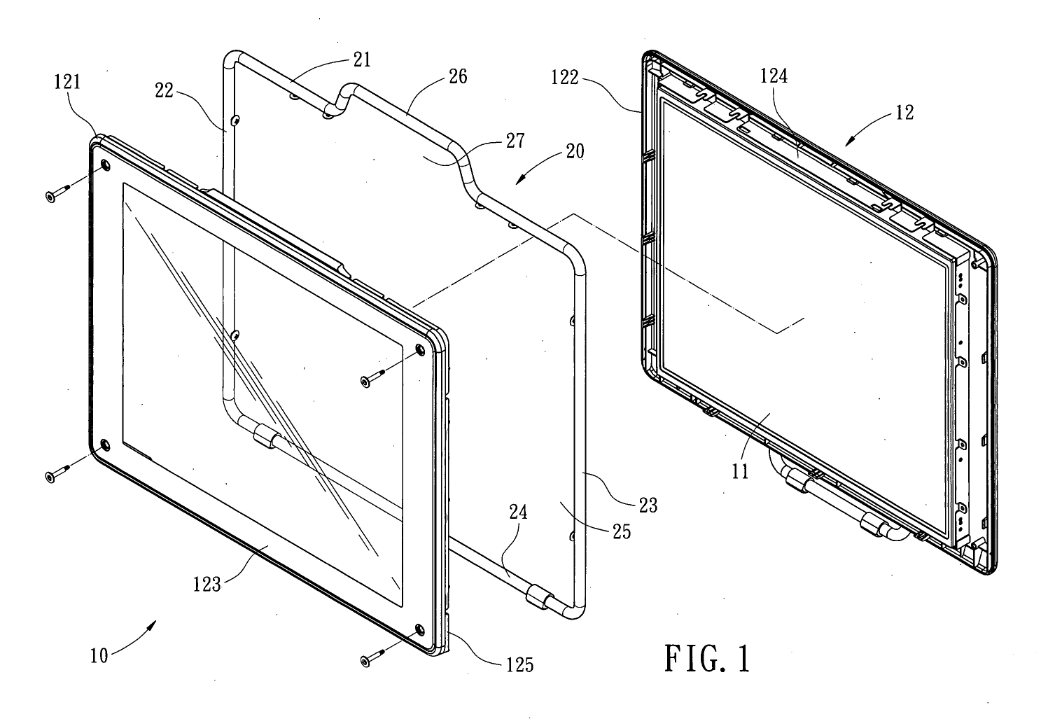

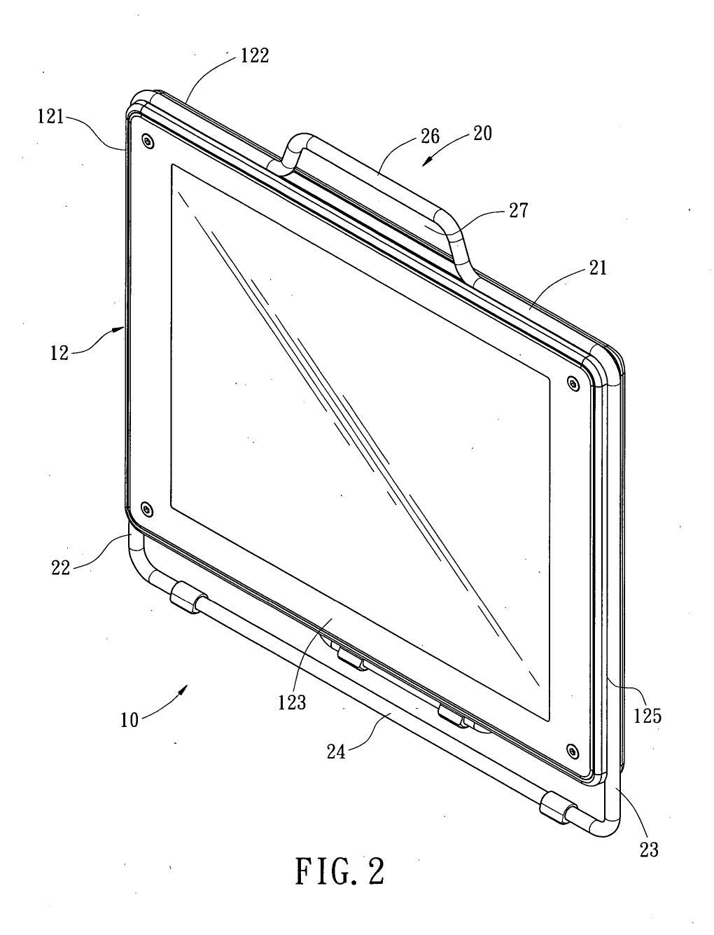

Referring to FIG. 1 and FIG. 2, the present invention provides a monitor frame which includes basically a frame body 20 which is securely connected to the display 10. The display 10 includes a display unit 11 and a cover body 12 which completely surrounds the circumference of the display unit 11. The display unit 11 may be either a liquid crystal or plasma display module. The cover body 12 which is made from plastic material is assembled by combining a primary case shell 121 with a secondary case shell 122. The protective plate 123 is installed before the primary case shell 121 in order to provide the display unit 11 with a protecting laminar. The secondary case shell 122 has a plurality of fixing tabs 124. The space enclosed by the fixing tabs 124 is utilized to install the display unit 11. The fixing tabs 124 have a plurality of clips which are formed at their outer edges and correspond to the primary case shell's 121 plurality of slots. These clips and slots are utilized in order to securely fix the primary case shell 121 to the secondary case shell 122. In addition, a conjunction portion 125 is formed around the outer circumference of the cover body 12. The conjunction portion 125 may be a rectangular concave groove, a semi-circle concave groove, or a flange concave groove. The conjunction portion 125 of the present invention is a semi-circle concave groove.

The frame body 20 may be constructed from tubular, beam, or plate material. The cross sectional shape of the frame body 20 may be a circle, a rectangle, or other geometric configuration. The present invention is constructed from tubular material. The frame body 20 is formed by enclosing a top beam 21, a left beam 22, a right beam 23, and a bottom beam 24. A receptive space 25, which is enclosed by the frame body 20, is utilized in order to install the display 10. The left beam 22 and the right beam 23 are connected to the conjunction portions 125 of the cover body 12. The widths of the left beam 22 and the right beam 23 are sized in accordance with the width of the conjunction portion 125. A handle 26 is formed on the top beam 21 of the frame body 20. The handle 26 has a reverse U-shaped configuration.

A receptive space 27, formed between the handle 26 and the display 10, is utilized when a hand is inserted into it for the purpose of grasping the handle 26. In addition, for the purpose of improved shock absorption, a space is retained between the bottom beam 24 and the bottom of the display 10.

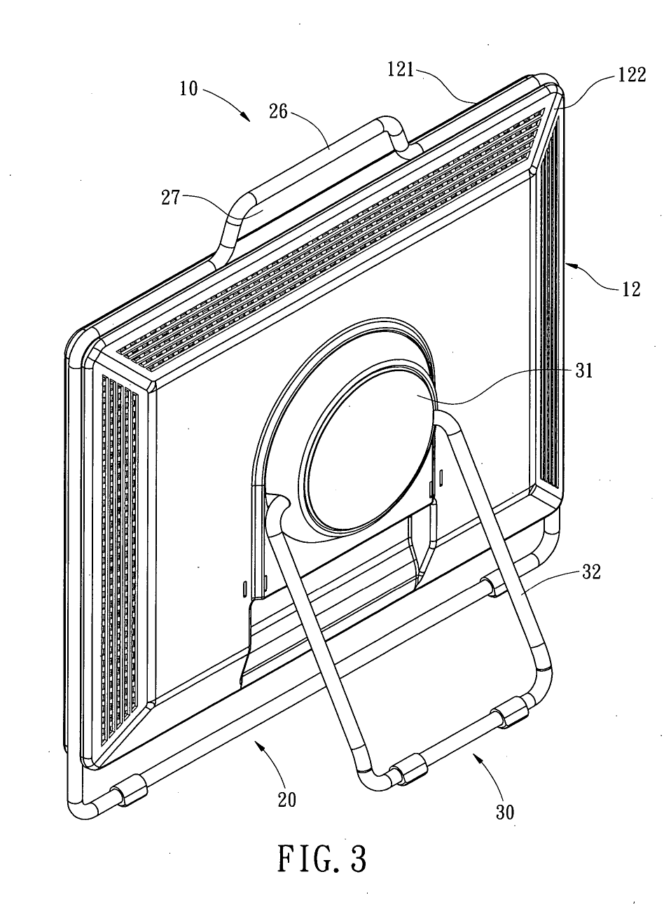

Referring to FIG. 3, a perspective view shows the first embodiment of the present invention and the usage of the supporting member 30. A supporting member 30 may be installed onto the rear of the secondary case shell 122. The supporting member 30 includes a rotatable disk 31 which is pivoted in order to create a stable structure for erection of the display 10.

To utilize the monitor, force is applied to unfold the supporting stand 32. Such an unfolding force is sufficient to rotate the bottom edge of the supporting stand 32 outward. Once rotated outward, a distance will have been created between the bottom of the frame body 20 and the bottom edge of the supporting stand 32. It is this distance that allows the frame body 20 to be propped up by the supporting member 30. This propping of the frame body 20 erects the display 10 on any table or other planar surface and provides the desired angle for viewing the display 10. Even if the display 10 is not equipped with the supporting member 30, the display 10 can be hung on a wall by utilizing the handle 26 of the frame body 20.

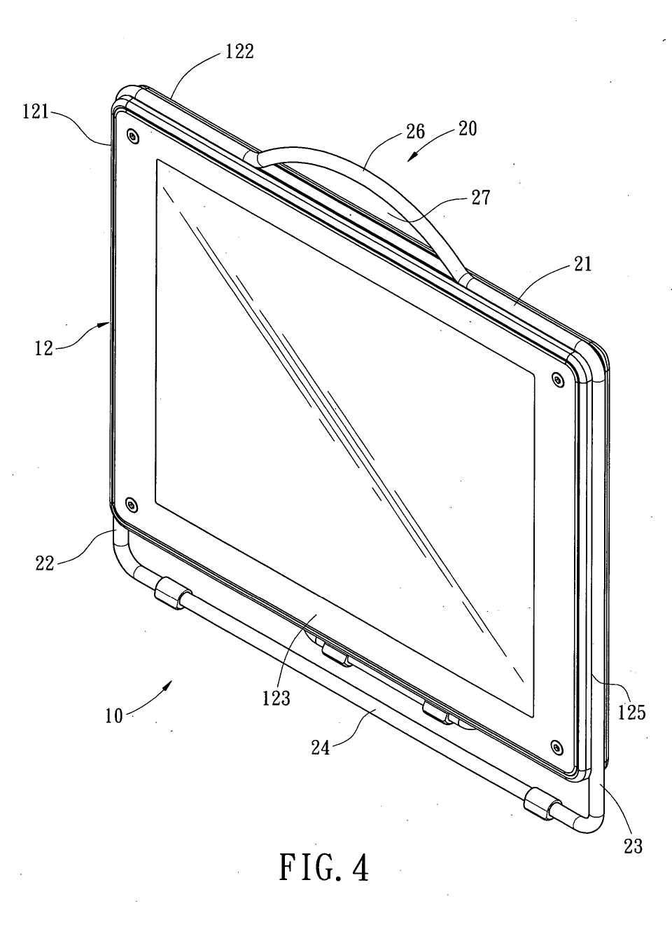

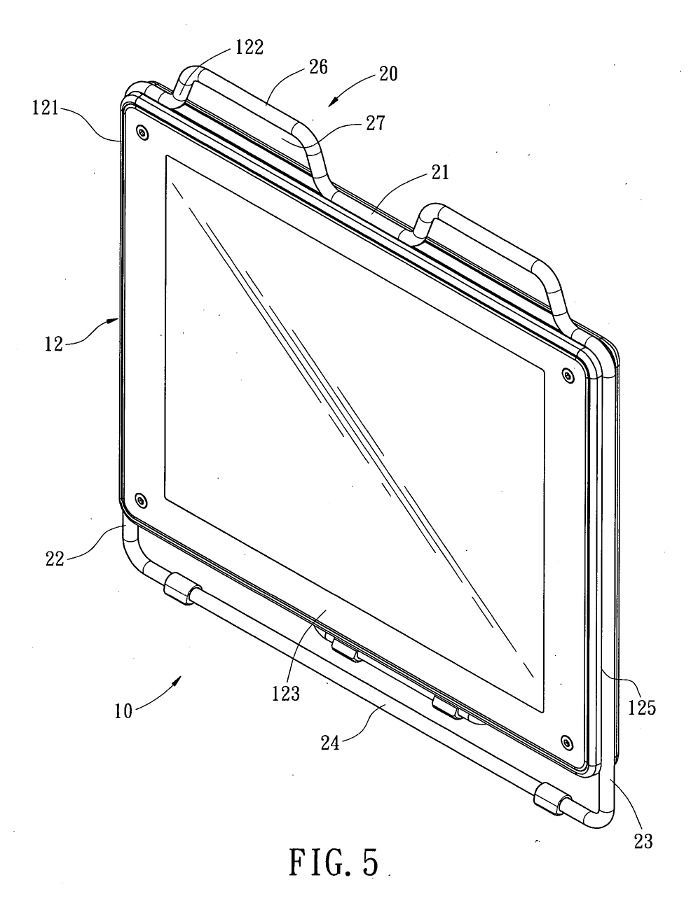

Referring to FIG. 4 and FIG. 5, the second and the third embodiments of the present invention, when fully assembled, are shown respectively. The configuration of the handle 26, depending on the style, volume, or weight of the display 10, may be integrated as an upside down semi arc as illustrated in FIG. 4, or a double reverse U-shape as illustrated in FIG. 5. The implementation of the handle 26 may also be based on other geometric configurations.

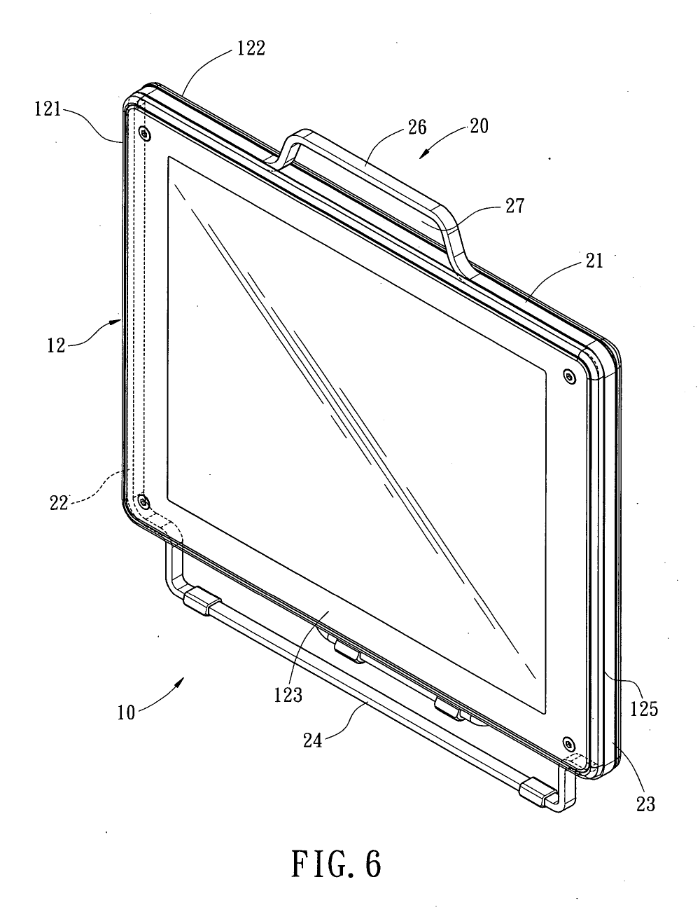

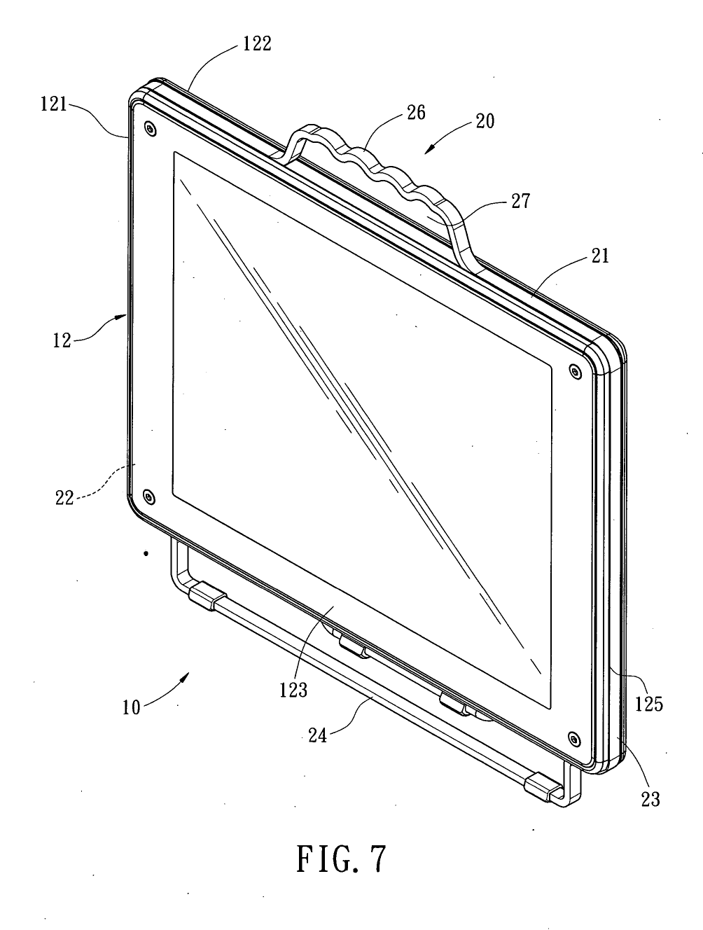

Referring to FIG. 6 and FIG. 7, the fourth and fifth embodiments of the present invention, when fully assembled, are shown respectively. The frame body 20 in these two embodiments, which is made from a single piece of plate material, is formed by means of continuous bending of the material. The thickness of the frame body 20 is selected so that it will fit into the space allotted by the conjunction portion 125 of the cover body 12. The outer surface of the frame body 20 is aligned and made flush with the edge of the cover body 12. Additionally, the top of the handle 26 may have an embossing or water wave design. The present invention, having the water wave design, increases the friction between a hand and the handle 26.

A monitor frame with a handle structure in accordance with the present invention is beneficial in at least three ways. First, the installation of the handle facilitates the easy carrying of a monitor. The handle can also be utilized to hang a monitor onto a wall. A monitor is thereby capable of more fully satisfying the needs of its owner since it can be adapted for use in various environments. Second, the frame body is able to protect the structure of the display because it completely encloses the display's circumference. This protection prevents the structure of the display from being cracked through impact on a hard surface. Third, by utilizing the support of the frame body and the supporting member, the monitor can be stably erected with a satisfactory slope on any table or other planar surface.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A monitor frame with an integrated handle structure, comprising:
a display; and
a frame body securely connected onto the display, wherein a handle is installed at one side of the frame body, and a receptive space is formed between the handle and the display capable of having a hand inserted for the purpose of grasping the handle.

2. The monitor frame of claim 1, wherein the frame body is made from tubular material, beam material, or plate material.

3. The monitor frame of claim 1, wherein the cross section of the frame body is either circular or rectangular.

4. The monitor frame of claim 1, wherein the frame body is formed by enclosing a top beam, a left beam, a right beam, and a bottom beam, a space preserved between the bottom beam and the bottom of the display.

5. The monitor frame of claim 1, wherein the handle is formed on the top beam of the frame body.

6. The monitor frame of claim 1, wherein the frame body and the handle are integrally formed.

7. The monitor frame of claim 1, wherein the configuration of the handle is a reverse U, a semi arc, or a double reverse U.

8. The monitor frame of claim 1, wherein the top of the handle may have embossing or water wave configuration.
